(19) United States
(12) Patent Application Publication
(10) Pub. No.: US 2026/0203167 A1
(43) Pub. Date: Jul. 16, 2026

(54) MEMORY CONTROLLER, STORAGE DEVICE AND METHOD OF OPERATION THEREOF

(71) Applicant: Samsung Electronics Co., Ltd., Suwon-si (KR)

(72) Inventors: Chang Hyun SONG, Suwon-si (KR); Dongeun SHIN, Suwon-sI (KR); Jinseob YANG, Suwon-si (KR)

(21) Appl. No.: 19/268,093

(22) Filed: Jul. 14, 2025

(30) Foreign Application Priority Data
Jan. 15, 2025 (KR) 10-2025-0006279

(51) Int. Cl. G06F 11/10

(52) U.S. Cl. CPC G06F 11/1068; G06F 11/1016; G06F 11/1048

(57) ABSTRACT

Provided is a memory controller, a storage device, and a method of operating a memory controller including: estimating, based on an error bit of a first memory block which is programmed among a plurality of memory blocks included in a memory device, a reclaim point of the first memory block: determining whether a reclaim is saturated based on a plurality of reclaim points of the plurality of the memory blocks; and, when the reclaim is determined to be saturated, moving at least one reclaim point among the plurality of reclaim points.

### CROSS-REFERENCE TO RELATED APPLICATIONS

This application claims the benefit, under 35 U.S.C. § 119, of Korean Patent Application No. 10-2025-0006279, filed on Jan. 15, 2025, in the Korean Intellectual Property Office, the disclosure of which is incorporated herein by reference in its entirety.

### BACKGROUND

Example embodiments relate generally to a memory controller, a storage device, and a method of operation thereof.

Memory devices are widely used to store data in electronic devices such as computers and wireless communication devices. To access the data stored in the memory device, at least one state of a memory cell may be detected. Also, to store data, the state of the memory cell may be maintained or changed. The data stored in the memory cell may be lost over time, and an operation may be required to prevent this from occurring.

### SUMMARY

An embodiment of the present disclosure provides a memory controller for efficiently performing a scheduled reclaim, a storage device including the memory controller, and an operation method of the memory controller.

Additional features and utilities of the present general inventive concept will be set forth in part in the description which follows and, in part, will become apparent to those of skill in the art from the description, or may be learned by practice of the general inventive concept.

According to an embodiment, there is provided an operation method of a memory controller, the operation method including estimating, based on an error bit of a first block which is programmed among a plurality of blocks included in a memory device, a reclaim point of the first block, determining whether a reclaim is saturated based on a plurality of reclaim points of the plurality of the blocks, and when the reclaim is determined to be saturated, moving at least one reclaim point among the plurality of reclaim points.

According to another embodiment, there is also provided a memory controller comprising at least one processor configured to control a memory device which includes a plurality of blocks. The at least one processor is configured to estimate, based on an error bit of a first block which is programmed among the plurality of blocks, a reclaim point of the first block, to determine whether a reclaim is saturated based on a plurality of reclaim points of the plurality of blocks, and to move at least one reclaim point among the plurality of reclaim points when the reclaim is determined to be saturated.

According to still another embodiment, there is provided a storage device including a memory device including a plurality of blocks, and a memory controller configured to write data to the memory device in response to a write request. The memory controller is configured to transmit a write command to the memory device to program a first block among the plurality of blocks, to estimate a reclaim point of the first block based on an error bit of the first block, to determine whether a reclaim is saturated based on a plurality of reclaim points of the plurality of blocks, and to move at least one reclaim point among the plurality of reclaim points when the reclaim is determined to be saturated.

Detailed descriptions of other example embodiments are included in the detailed description and drawings.

According to example embodiments, it is possible to extend a life span of a memory device, and a reclaim may be performed efficiently within an available performance range of the memory device.

Effects of the present disclosure are not limited to those described above, and other effects may be made apparent to those skilled in the art from the following description.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a system according to example embodiments of the present disclosure;

FIG. 2 is a block diagram for describing a memory device according to example embodiments of the present disclosure;

FIG. 3 is a block diagram for describing a memory controller according to example embodiments of the present disclosure;

FIG. 4 is a block diagram illustrating a memory controller and a memory device according to example embodiments of the present disclosure;

FIG. 5 is a graph describing an error bit according to example embodiments of the present disclosure;

FIG. 6 is a graph which may assist in describing a method of determining a trend of an error bit according to example embodiments of the present disclosure;

FIG. 7 is a drawing for describing reclaim points included in a unit time interval according to example embodiments of the present disclosure;

FIG. 8 is a graph which may assist in describing a method of moving a reclaim point according to example embodiments of the present disclosure;

FIG. 9 is a drawing for describing reclaim points included in a unit time interval according to example embodiments of the present disclosure;

FIG. 10 is a block diagram illustrating a memory controller and a memory device according to example embodiments of the present disclosure;

FIG. 11 is a graph which may assist in describing a method of moving a reclaim point according to example embodiments of the present disclosure;

FIG. 12 is a flowchart illustrating an operation method of a memory controller according to example embodiments of the present disclosure;

FIG. 13 is a flowchart illustrating an operation method of a memory controller according to example embodiments of the present disclosure; and

FIG. 14 is a block diagram of a memory controller according to example embodiments of the present disclosure.

### DETAILED DESCRIPTION

Terms used in the example embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. Accordingly, it should be noted that the terms used herein should be construed based on practical meanings thereof and the whole content of this specification, rather than being simply construed based on names of the terms.

In the entire specification, when an element is referred to as “comprising” or “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software.

In the following description, example embodiments of the present disclosure will be described in detail with reference to accompanying drawings so that those skilled in the art can easily carry out the present disclosure. The present disclosure may be applied in many different forms and is not limited to the embodiments described herein.

Hereinafter, example embodiments of the present disclosure will be described with reference to the drawings, wherein like reference numerals (when used) indicate corresponding elements throughout the several views.

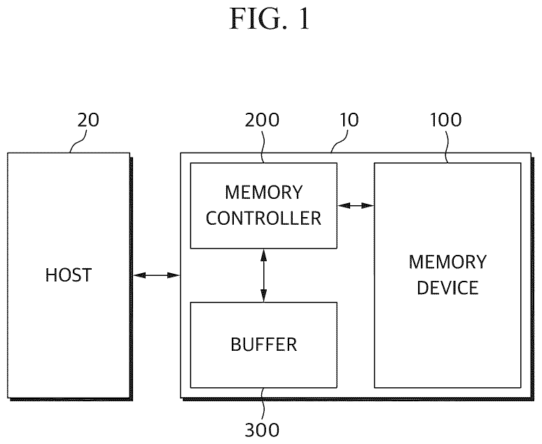

FIG. 1 is a block diagram illustrating a system according to example embodiments of the present disclosure. For example, the block diagram of FIG. 1 illustrates a host-storage system as an example of the system.

Referring to FIG. 1, the host-storage system may include a host 20 and a storage device 10 operatively coupled to the host 20. The host 20 may include a host controller and a host memory. The host controller may generate data to be stored in the storage device 10, and may process data received from the storage device 10. The host memory may function as a buffer memory for temporarily storing data to be transmitted to the storage device 10 or data received from the storage device 10.

According to an example embodiment, each of the host controller and host memory may be embodied as a separate semiconductor chip. According to an example embodiment, each of the host controller and host memory may be integrated in the same semiconductor chip. As an example, the host controller may be one of several modules provided in an application processor, and the application processor may be embodied as a system-on-chip (SoC). In addition, the host memory may be an embedded memory provided within the application processor, or a memory device or memory module placed outside the application processor.

The host controller may control operations of storing data of a buffer memory (e.g., program data) into a memory device 100 or storing data of the memory device 100 (e.g., data read) into the buffer memory.

The storage device 10 may include the memory device 100, a memory controller 200, and a buffer 300. The storage device 10 may include storage media for storing data in response to requests from the host 20. For example, the storage device 10 may include at least one of solid-state drive (SDD), embedded memory, and detachable external memory. When SSD is used as the storage device 10, the storage device 10 may comply with the non-volatile memory express (NVMe) standards.

When an embedded memory or external memory is used as the storage device 10, the storage device 10 may comply with the universal flash storage (UFS) standards or embedded multi-media card (eMMC) standards. Each of the host 20 and the storage device 10 may generate and transmit packets based on the employed standard protocol.

When the memory device 100 of the storage device 10 includes flash memory, the flash memory may include two-dimensional (2D) NAND memory array or three-dimensional (3D) NAND (or vertical NAND (VNAND)) memory array. As an example, the storage device 10 may include other types of memory devices. For example, the storage device 10 may include various types of memory devices such as magnetic random-access memory (MRAM), spin-transfer torque MRAM (STT-MRAM), and resistive memory (resistive RAM).

The buffer 300 may include a buffer memory required for the memory controller 200 to access the memory device 100 and process requests from the host 20. As an example, the buffer 300 may include static random-access memory (SRAM).

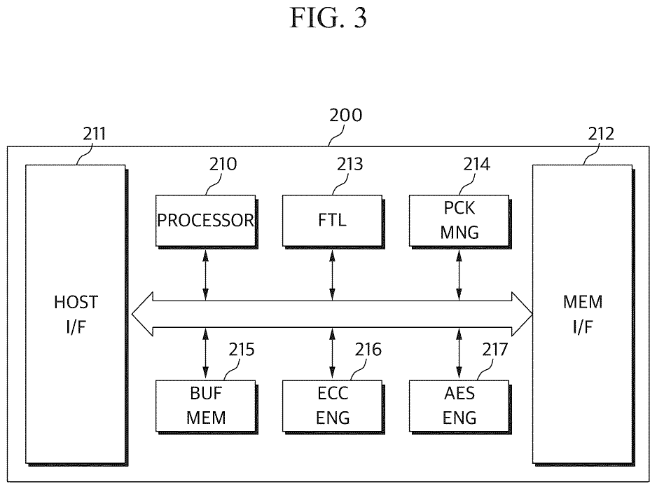

According to an example embodiment, the storage device 10 may receive a read or write request from the host 20. The storage device 10 may include an interface (e.g., Host I/F 211 of FIG. 3) configured for forwarding the read or write request received from the host 20 to the memory controller 200, or for forwarding data provided by the memory controller 200 to the host 20. This will be described in greater detail with reference to FIG. 3.

The memory controller 200 may access the memory device 100 in response to the request of the host 20. For example, the memory controller 200 may transmit a read command to the memory device 100 in response to the read request. The memory controller 200 may transmit a write command to the memory device 100 in response to the write request from the host 20. Also, the memory controller 200 may command the memory device 100 to perform an erase operation. Here, the command the memory controller 200 sends to the memory device 100 may include an address and a control signal.

Also, the memory controller 200 may control the memory device 100. For example, the memory controller 200 may schedule a reclaim point (or timing) of a plurality of blocks included in the memory device 100. Also, the memory controller 200 may control the memory device 100 to perform the scheduled reclaim.

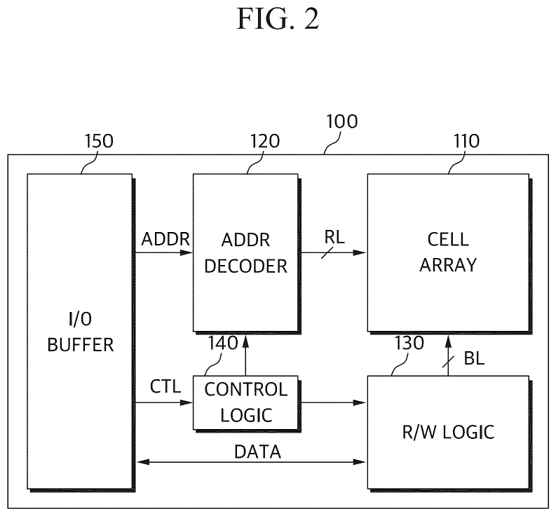

FIG. 2 is a block diagram for describing the memory device 100 according to example embodiments of the present disclosure. For example, the memory device 100 of FIG. 2 may be an example of the memory device 100 include in the storage device 10 of FIG. 1.

Referring to FIG. 2, the memory device 100 may include a cell array 110, an address decoder 120, a read/write (R/W) logic 130, a control logic 140, and an input/output (I/O) buffer 150.

The cell array 110 may be connected to the address decoder 120 through a plurality of row lines RL and connected to the read/write logic 130 through a plurality of bit lines BL. Here, the plurality of row lines RL may include a plurality of string lines, plurality of word lines, and plurality of ground select lines, for example.

The cell array 110 may include a plurality of blocks (or plurality of memory blocks). In addition, each of the plurality of blocks may include at least one page. Here, the block may be a unit of erasure in the memory device 100, and the page may be a unit of read or write of the memory device 100. Meanwhile, a random operation for the block in the present disclosure may be understood as an operation for the page included in the block. For example, a read operation on an error bit of a random block and the random block may be a read operation on an error bit of data read from a specified page included in the random block and the specified page included in the random block.

The address decoder 120 may be connected to the cell array 110, a control logic 140, and the input/output buffer 150. The address decoder 120 may decode an address ADDR received through the input/output buffer 150. For example, the address decoder 120 may acquire a block address of the cell array 110 by decoding the received address ADDR and use the acquired block address to access the block of the cell array 110.

The address decoder 120 may include a row decoder. The address decoder 120 may acquire a row address by using the row decoder to decode the received address ADDR and use the row address to select a word line corresponding to the row address among a plurality of word lines of a block selected in the cell array 110. According to example embodiments, the address decoder 120 may include a column decoder. The address decoder 120 may acquire a column address by decoding the received address ADDR using the column decoder, and forward it to the read/write logic 130.

The read/write logic 130 may be connected to the cell array 110 through the plurality of bit lines BL. According to example embodiments, the read/write logic 130 may receive the column address decoded by the address decoder 120, and may select bit lines corresponding to the decoded column address under the control of control logic 140.

For example, the read/write logic 130 may write data DATA received through the input/output buffer 150 to memory cells connected to the word line selected from the cell array 110. Meanwhile, the read/write logic 130 may read the data DATA from selected bit lines corresponding to the decoded column address among the plurality of bit lines BL and forward it to the input/output buffer 150. In addition, the read/write logic 130 may perform a copy-pack operation of writing data read from one region of the cell array 110 to another region. The read/write logic 130 may also include a page buffer, page resistor, column selection circuit, sense amplifier, and write driver, for example.

The control logic 140 may be connected to the address decoder 120, read/write logic 130, and input/output buffer 150. The control logic 140 may control overall operations of the memory device 100 based on a control signal CTL provided through the input/output buffer 150 from an external source.

The input/output buffer 150 may be connected to the address decoder 120, control logic 140, and read/write logic 130. The input/output buffer 150 may forward an address ADDR and control signal CTL provided from an external source to the address decoder 120 and control logic 140, respectively. As an example, the input/output buffer 150 may forward data DATA received with a write request from the host 20 to the read/write logic 130, or forward data DATA the read/write logic 130 read from the cell array 110 to the memory controller 200.

FIG. 3 is a block diagram for describing the memory controller 200 according to example embodiments of the present disclosure. For example, the memory controller 200 of FIG. 3 may be an example of the memory controller 200 include in the storage device 10 of FIG. 1.

The memory controller 200 may include a processor 210, a host interface 211, and a memory interface (I/F) 212. In addition, the memory controller 200 may also include a flash translation layer (FTL) 213, a packet manager 214, a buffer memory 215, an error correction code (ECC) engine 216, and an advanced encryption standard (AES) engine 217. The respective components of the memory controller 200 may be connected together via a data bus or other connection means.

The processor 210 may control overall operations of the memory controller 200. The processor 210 may process various calculations required to operate the memory controller 200. As an example, the processor 210 may be a central processing unit (CPU).

The memory controller 200 may also include a working memory to which the flash translation layer 213 is loaded. In addition, a read and write operation of data for the memory device 100 (see FIG. 1) may be controlled by the processor 210 executing the flash translation layer 213.

According to an example embodiment, the host interface 211 may transmit or receive a packet to or from the host 20 (see FIG. 1). The packet transmitted to the host interface 211 from the host 20 may include a command and/or data to be written to the memory device 100, for example, and the packet transmitted from the host interface 211 to the host 20 may include a response to the command and/or data read from the memory device 100, and the like.

The memory interface 212 may transmit data to be written to the memory device 100 to the memory device 100 or receive data read from the memory device 100 from the memory device 100. According to an example embodiment, the memory interface 212 may be implemented to comply with standard regulations such as Toggle or ONFI.

The flash translation layer 213 may perform address mapping, wear-leveling, and garbage collection, for example. The address mapping may refer to an operation of converting a logical address received from the host into a physical address used for actually storing data within the memory device 100. The wear-leveling may ensure that the blocks within the memory device 100 are used equally, thereby preventing excessive deterioration of a specific block, and it may be implemented, for example, through firmware that balances the erase counts of physical blocks. The garbage collection may increase available memory device 100 capacity by copying valid data of a block into a new block and erasing the existing block.

The packet manager 214 may generate a packet complying with a protocol of an interface between the packet manager 214 and the host 20 or parse different kinds of information from the packet received from the host 20.

The buffer memory 215 may temporarily store data to be written to the memory device 100 or data read from the memory device 100. The buffer memory 215 may be included in the buffer 300 provided within the storage device 10 as illustrated in FIG. 1, or may be included within the memory controller 200 as illustrated in FIG. 3, but this is merely an example.

The ECC engine 216 may detect and correct errors of data read from the memory device 100. For example, the ECC engine 216 may generate parity bits of write data to be written to the memory device 100. The parity bits may be stored within the memory device 100 with the write data. When reading data from the memory device 100, the ECC engine 216 may detect and correct errors of data read using the parity bits together with the data read, and may output the data read with errors corrected.

The AES engine 217 may perform at least one of encryption or decryption of data input to the memory controller 200. According to an example embodiment, the AES engine 217 may perform encryption and/or decryption using a symmetric-key algorithm.

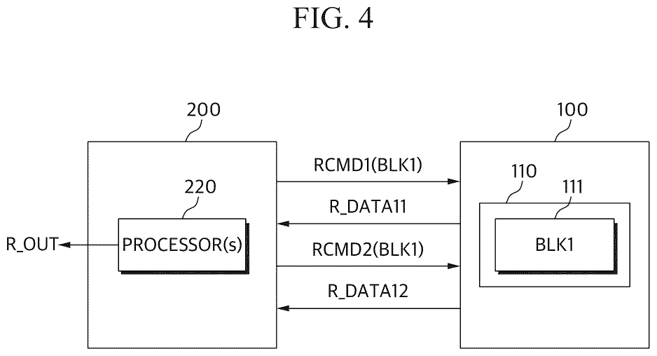

FIG. 4 is a block diagram illustrating a memory controller and a memory device according to example embodiments of the present disclosure. The memory controller 200 may include at least one processor 220. The at least one processor 220 of FIG. 4 may include the processor 210 of FIG. 3, and may also include at least one of the flash translation layer 213, packet manager 214, buffer memory 215, ECC engine 216, or AES engine 217 of FIG. 3. Hereinafter, operations performed by the at least one processor 220 may be referred to as operations of the memory controller 200, and may be referred to as an operation of at least one of the processor 210, flash translation layer 213, packet manager 214, buffer memory 215, ECC engine 216, or AES engine 217.

Referring to FIG. 4, the cell array 110 included in the memory device 100 may include at least one block. As an example, a random block included in the cell array 110 is referred to as a first block 111 which is also indicated as BLK1.

According to an example embodiment, the memory controller 200 may read data stored in the cell array 110 by transmitting a read command to the memory device 100 or write data to the cell array 110 by transmitting a write command to the memory device 100.

Meanwhile, the memory controller 200 may transmit more than one read command to the memory device 100. For example, the memory controller 200 may read a first data R_DATA11 stored in the first block 111 by transmitting a first read command RCMD1(BLK1) for the first block 111 of the memory device 100. Then, the memory controller 200 may read a second data R_DATA12 stored in the first block 111 by transmitting a second read command RCMD2(BLK1) for the first block 111 of the memory device 100. The first data R_DATA11 and the second data R_DATA12 may be different from each other and may have different error bits, as will be described later.

The memory controller 200 may detect errors of data read such as the first data R_DATA11 and the second data R_DATA12. As an example, the at least one processor 220 may detect error bits of the data read. The at least one processor 220 may transmit data with errors corrected to the host 20 (see FIG. 1) as the final data read R_OUT.

The memory controller 200 or the at least one processor 220 may perform a reclaim. At least a part of data stored in the cell array 110 may be lost over time due to various reasons, and error bits may increase as the result. The reclaim may refer to an operation of erasing data stored in a memory block and re-writing the data before an uncorrectable error occurs in the data stored in the memory block. The cell array 110 may include a plurality of blocks, and when the reclaim is performed on the plurality of blocks at once because of bad blocks, good blocks may be excessively degraded or have shortened life span as unnecessary program and erase (P/E) cycle is repeated.

According to an example embodiment, the at least one processor 220 may perform reclaim on the first block 111 based on an error bit of the first block 111. The term “reclaim” in the context of a memory system based on an error bit or error rate generally involves selectively reclaiming memory areas that exhibit a higher error rate, often by migrating data from degraded blocks to healthier ones in order to prevent or reduce data corruption. For example, the at least one processor 220 may determine a reclaim point of the first block 111 based on the error bit of the first block 111. The at least one processor 220 may perform reclaim on the first block 111 at the determined reclaim point.

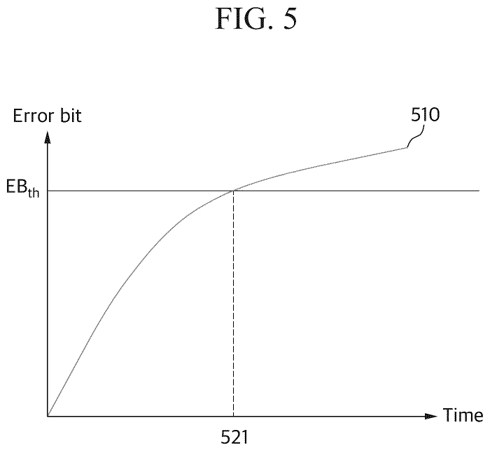

FIG. 5 is a graph which may assist in describing an error bit according to example embodiments of the present disclosure. For example, FIG. 5 is a graph illustrating an error bit over time.

According to an example embodiment, the at least one processor 220 (see FIG. 4) may estimate a reclaim point of the first block based on an error bit of the first block which is a programmed block among a plurality of blocks. Here, for the first block, as a programmed block, a trend 510 of the error bit based on the following description may be determined immediately after programming. As an example, the at least one processor 220 may estimate the reclaim point of the first block once the programming of the first block is completed. As another example, the at least one processor 220 may estimate the reclaim point of the first block after a predetermined number of programmed blocks including the first block have occurred, and an example embodiment of estimating a reclaim point of the programmed first block is not limited thereto.

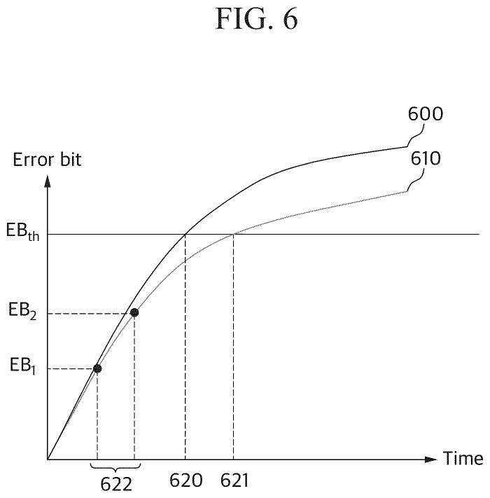

As an example, the at least one processor 220 may determine the trend 510 of the error bit based on the error bit of the data read from the first block. As illustrated in FIG. 5, the error bit of the first block may have a tendency of increasing by time. A method of determining the trend 510 of the error bit of the first block will be described in greater detail with reference to FIG. 6.

The error bit may increase as electrical characteristics of a plurality of blocks may change as the runtime increases. Therefore, reclaiming needs to be performed at an appropriate time, before error bits of the block increases excessively, to maintain reliability and performance of the memory device 100. However, memory cells forming each of the blocks can withstand a predetermined number of program/erase cycles, and when the reclaim is performed more times than necessary, the life span of the memory cell may decrease as the number of programming and erasing increases, leading to inefficient operation of the memory device 100. In addition, based on the performance of the memory device 100 or storage device 10, the number of blocks on which reclaim can be performed at a specified point may be limited, and when reclaim points of the blocks are concentrated, the reclaim may not be performed properly. Accordingly, a method of performing reclaims efficiently based on reclaim points required by each of the plurality of blocks through reclaim scheduling is required.

According to an example embodiment, the at least one processor 220 may identify a reclaim point 521 based on the trend 510 of an error bit and a threshold error bit EBₜₕ. As an example, the at least one processor 220 may estimate a point at which the trend 510 of the error bit of the first block equals or exceeds the threshold error bit EBₜₕ as the reclaim point 521 of the first block. This may indicate that it is determined to perform reclaim at the reclaim point 521 which is a future point at which the error bit of the first block becomes the threshold error bit EBₜₕ.

According to an example embodiment, the threshold error bit EBₜₕ may be set based on an error-correctable threshold value. For example, the threshold error bit EBₜₕ may be set at a predetermined ratio of the error-correctable threshold value using the at least one processor 220, that is, the ECC engine 216 of FIG. 3, for example. Specifically, when the error-correctable threshold value is 300 bits, the threshold value EBₜₕ may be set to 270 bits, which is 90% of the error-correctable threshold value.

According to an example embodiment, the threshold error bit EBₜₕ may be set based on the characteristics of the memory device 100. For example, the threshold error bit EBₜₕ may be set as a characteristic value of the memory device 100. According to another example embodiment, the threshold error bit EBₜₕ may be set based on the life span of each of the plurality of blocks. For example, the threshold error bit EBₜₕ may be set lower as the P/E cycle of each of the plurality of blocks becomes shorter. According to another example embodiment, the threshold error bit EBₜₕ may be a value set regardless the factors described above.

FIG. 6 is a graph which may assist in describing a method of determining a trend of an error bit according to example embodiments of the present disclosure.

Referring to FIG. 6, an initial trend 600 of an error bit of the first block is shown. The initial trend 600 may be a predetermined value for the first block. For example, the initial trend 600 may be a predetermined value reflecting an average of trends of error bits of a plurality of blocks of the memory device 100.

According to an example embodiment, the at least one processor 220 (see FIG. 4) may read data stored in the first block more than once. For example, the at least one processor 220 may acquire a first read data and a second read data based on each of two or more read commands for the first block.

According to an example embodiment, the at least one processor 220 may detect error bits EB₁, EB₂ that were read more than once. For example, the at least one processor 220 may detect an error bit EB₁ of the first read data which is read from the first block based on a first read command, and detect an error bit EB₂ of the second read data which is read from the first block based on a second read command transmitted after the first read command. Here, since the first read command and the second read command are transmitted with a time interval 622 in between, values of the error bits EB₁ and EB₂ detected from the first read data and the second read data respectively may differ from each other. For example, the number of error bits EB₂ detected from the second data may be greater than the error bits EB₁ detected from the first read data, and the number may increase as the time interval 622 increases.

According to an example embodiment, the at least one processor 220 may determine a trend 610 of an error bit of the first block by correcting the initial trend 600 based on the error bits EB₁ and EB₂ of data which were read more than once. For example, the initial trend 600 may be corrected by fitting a trend line based on the error bits EB₁ and EB₂ of data read more than once.

The at least one processor 220 may estimate a reclaim point for each of a plurality of blocks by determining a trend of an error bit of each of the plurality of blocks. Through this, efficiency of the reclaim may be increased. For example, a reclaim point 620 estimated based on the initial trend 600 of the first block and the threshold error bit EBₜₕ may be ahead of a reclaim point 621 estimated based on the trend 610 of the error bit of the first block and the threshold error bit EBₜₕ. That is, according to an example embodiment of the present disclosure, an unnecessary reclaim of the first block may be omitted, and the first block may be prevented from having a shortened life span.

According to an example embodiment, the determined trend 610 of the error bit of the first block may be stored in a memory or a separate database in the form of lookup table data, binary data, and time-series data, for example. Accordingly, a trend of an error bit of each of a plurality of programmed blocks including the first block may be stored in the memory in a single format among various formats available.

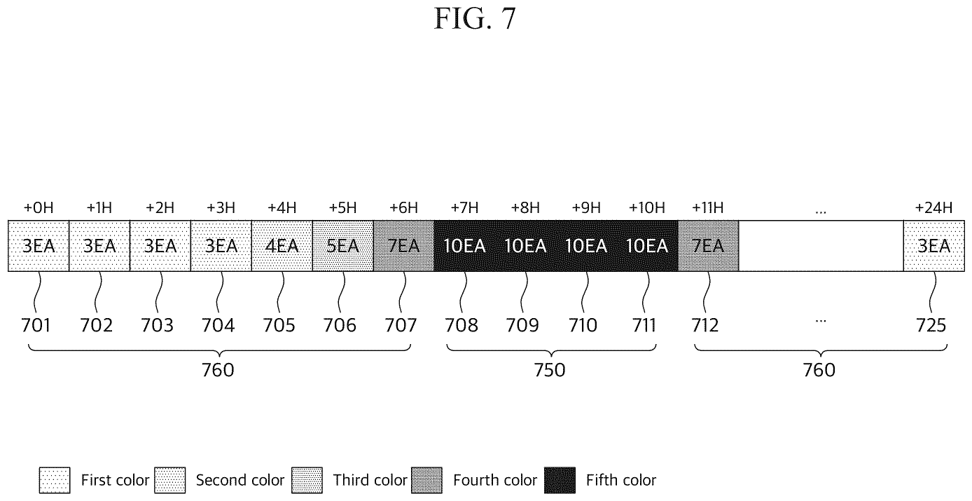

FIG. 7 is a drawing for describing a reclaim point included in a unit time interval according to example embodiments of the present disclosure.

Referring to FIG. 7, a plurality of unit time intervals 701 to 725 including a zeroth time interval 701 in which the present point is included are illustrated. For example, starting from the zeroth time interval 701, a first time interval 702 corresponding to one unit of time elapsed, a second time interval 703 corresponding to two units of time elapsed, a third time interval 704 corresponding to three units of time elapsed, and so on are illustrated. Although a unit time and the length of the unit time interval is illustrated as one hour, this is merely an example, and the unit time and length of the unit time interval are not limited to one hour.

According to an example embodiment, the at least one processor 220 (see FIG. 4) may determine whether a reclaim is saturated based on a plurality of reclaim points of a plurality of blocks. Specifically, the at least one processor 220 may identify the number of reclaim points included in a unit time interval. According to the above-described example embodiments, a programmed block may have a reclaim point estimated by the at least one processor 220. Therefore, the at least one processor 220 may identify the number of reclaim points included in each of a plurality of unit time intervals by mapping the plurality of reclaim points of each of the plurality of blocks to a corresponding unit time interval. For example, when three reclaim points are included in the first time interval 702, a reclaim on three blocks may be performed in the first time interval 702.

According to an example embodiment, the at least one processor 220 may compare identified number of reclaim points with a threshold number. Specifically, the at least one processor 220 may compare reclaim points included in each of the plurality of unit time intervals with the threshold number. In addition, the at least one processor 220 may identify a unit time interval with reclaim points less than the threshold number and a unit time interval with reclaim points greater than the threshold number. For example, when the threshold number is 10, the at least one processor 220 may identify a unit time interval with less than 10 reclaim points and a unit time interval with 10 or more reclaim points. The threshold number may refer to the maximum number of blocks that can be reclaimed in a unit time interval.

According to an example embodiment, the at least one processor 220 may identify a non-saturated unit time interval 760 in which the number of identified reclaim points is less than the threshold number. In addition, the at least one processor 220 may identify a saturated unit time interval in which the number of identified reclaim points is more than the threshold number.

For example, an example embodiment is provided which includes zeroth to third time intervals 701 to 704 including 3 reclaim points, a fourth time interval 705 including 4 reclaim points, a fifth time interval 706 including 5 reclaim points, a sixth time interval 707 including 7 reclaim points, seventh to tenth time intervals 708 to 711, respectively, each including 10 reclaim points, and an eleventh time interval 712 including 7 reclaim points, and the threshold number in this example is 10. Here, the at least one processor 220 may identify the zeroth to sixth time intervals 701 to 707 and eleventh to twenty-fourth time intervals 712 to 725 as a non-saturated unit interval 760, and may identify the seventh to tenth time intervals 708 to 711 as a saturated unit interval 750.

In FIG. 7, the plurality of unit time intervals which are color coded based on the number of reclaim points included in each of the plurality of unit time intervals is illustrated. As an example, the at least one processor 220 may classify the plurality of unit time intervals based on the number of reclaim points included in each of the plurality of unit time intervals. However, the method of the at least one processor 220 classifying the plurality of unit time intervals is not limited to the method illustrated by the block diagram of FIG. 7.

For example, the plurality of unit time intervals may be classified as different groups based on the number of reclaim points. As an example, the at least one processor 220 may classify time intervals with 3 and 4 reclaim points as the same group, and may classify time intervals with 6, 8, and 9 reclaim points, which are not illustrated in FIG. 7, as a different group.

According to an example embodiment, the at least one processor 220 may determine that a reclaim is saturated when the saturated unit time intervals 750 of a predetermined number or higher occurs in succession. For example, when the predetermined number is 3, the at least one processor 220 may determine that the reclaim is saturated when more than two saturated unit time intervals 750 occurs in succession. Like the above-described example embodiment, when the seventh to tenth time intervals 708 to 711 are identified as the saturated unit time interval 750 and the predetermined number is 3, the at least one processor 220 may determine that the reclaim is saturated.

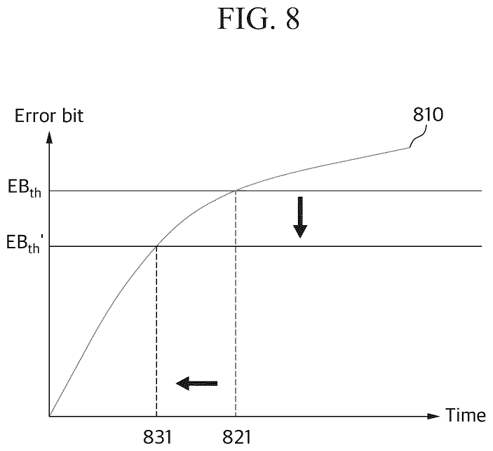

FIG. 8 is a graph which may assist in describing a method of moving a reclaim point according to example embodiments of the present disclosure.

According to an example embodiment, the at least one processor 220 (see FIG. 4) may move at least one reclaim point among a plurality of reclaim points when a reclaim is determined to be saturated. As an example, the at least one processor 220 may move a reclaim point 821 by changing a threshold error bit EBₜₕ.

Referring to FIG. 8, a trend 810 of an error bit of the first block, the threshold error bit EBₜₕ, and the reclaim point 821 which is determined based on the trend 810 and threshold error bit EBₜₕ are illustrated. Here, when a reclaim is determined to be saturated based on the reclaim point 821 of the first block, the at least one processor 220 may change the threshold error bit EBₜₕ. Accordingly, a moved reclaim point 831 may be determined based on the trend 810 of the error bit of the first block and the changed threshold error bit EBₜₕ′. As the trend 810 of the error bit of the first block has a tendency of increasing over time, when the changed threshold value EBₜₕ′ is less than the threshold error bit EBₜₕ, the moved reclaim point 831 may be determined to be a point ahead of (i.e., earlier in time relative to) the reclaim point 821.

According to an example embodiment, the at least one processor 220 may change the threshold error bit EBₜₕ based on error bits of blocks corresponding to a saturated unit time interval and error bits of blocks corresponding to a non-saturated unit time interval.

Referring back to FIG. 7, as an example, the at least one processor 220 may change the threshold error bit based on a difference between an average of error bits of blocks corresponding to the saturated unit time interval 750 and an average of error bits of blocks corresponding to the non-saturated unit time interval 760. Specifically, the at least one processor 220 may move the reclaim point by reducing the threshold error bit by the size of the difference between the average of error bits of blocks (e.g., blocks of which reclaim points are included in the saturated unit time interval 750) corresponding to the saturated unit time interval 750 and the average of error bits of blocks (e.g., blocks of which reclaim points are included in the non-saturated unit time interval 760) corresponding to the non-saturated unit time interval 760.

As an example, the at least one processor 220 may change the threshold error bit based on a difference between an average of error bits of blocks corresponding to one saturated unit time interval (e.g., 710) and an average of error bits of blocks corresponding to one non-saturated unit time interval (e.g., 705). For example, when the threshold error bit is 280 bits, and an average of error bits of blocks of a ninth time interval 710 in which reclaim points are included is 100 bits, and an average of error bits of blocks of a fourth time interval 705 in which reclaim points are included is 70 bits, the at least one processor 220 may change the threshold error bit to 250 bits. Here, when an estimated reclaim point of the first block is included in the ninth time interval 710, the reclaim point moved due to the changed threshold error bit may be determined to be the fourth time interval 705.

As an example, the at least one processor 220 may change the threshold error bit based on the number of saturated unit time intervals 750. For example, the at least one processor 220 may move the threshold error bit further when the number of saturated unit time interval 750 increases. Specifically, the at least one processor 220 may reduce the threshold error bit further when the number of the saturated unit time interval 750 is 5 compared to when the number of saturated unit time interval 750 is 4, as illustrated in FIG. 7.

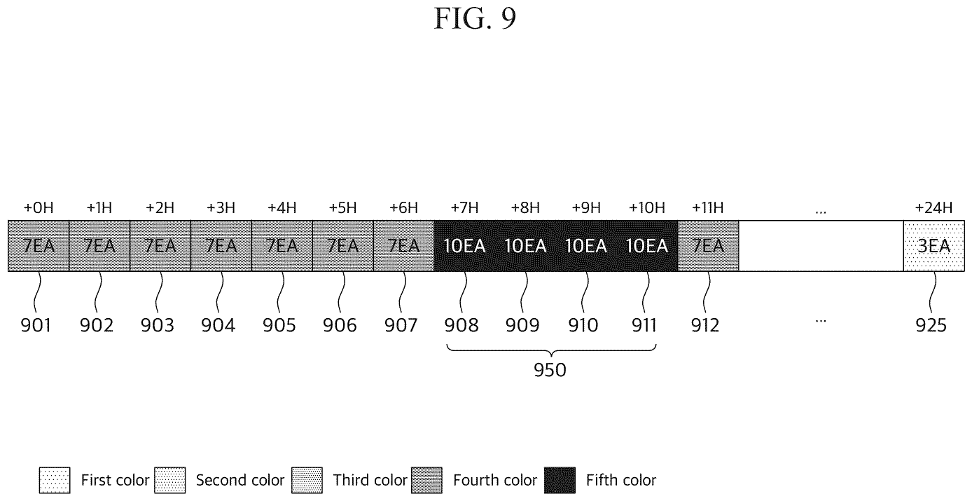

FIG. 9 is a drawing for describing reclaim points included in a unit time interval according to example embodiments of the present disclosure.

Based on the example embodiments described above, the reclaim of the first block may be performed on a unit time interval, which is not a saturated unit time interval 950, among a plurality of unit time intervals 901 to 925 and relieve saturation of the memory 100 (see FIG. 2).

Accordingly, when a reclaim of the memory device 100 is determined to be saturated, the at least one processor 220 may move reclaims points of each programmed block to a point ahead of the saturated unit time interval 950. Accordingly, the plurality of reclaim points are represented to be appropriately scheduled within an available performance range of the memory device 100.

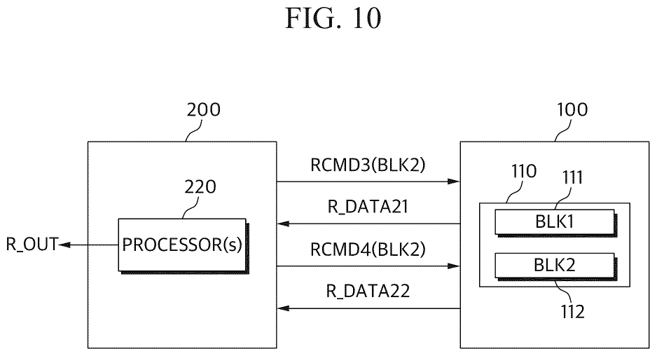

This will be described in greater detail with reference to FIG. 10.

FIG. 10 is a block diagram illustrating the memory controller 200 and the memory device 100 according to example embodiments of the present disclosure. As illustrated in FIG. 10, the memory controller 200 may include the at least one processor 220, and the memory device 100 may include the cell array 110.

Referring to FIG. 10, the cell array 110 included in the memory device 100 may include a plurality of blocks. According to an example embodiment, the plurality of blocks may include the first block 111 which is also indicated as BLK1, and a second block 112 which is also indicated as BLK2. Here, the second block 112 may be a block which was programmed later than the first block 111.

According to an example embodiment, the memory controller 200 may read data R_DATA 21, and R_DATA 22 stored in the second block 112 by transmitting at least one read command RCMD3(BLK2) and RCMD4(BLK2) each for the second block 112 to the memory device 100. The memory controller 200 may detect error bits of the data read R_DATA21 and R_DATA22 of the second block 112. The at least one processor 220 may transmit the data read with errors corrected to the host 20 as the final data read R_OUT of the second block 112. Among operations of the second block 112 of the memory controller 200 a description overlapping with the operation of the first block 111 described above with reference to FIG. 4 will be omitted.

According to an example embodiment, the at least one processor 220 may perform a reclaim on the second block 112 based on an error bit of the second block 112. For example, the at least one processor 220 may determine a reclaim point of the second block 112 based on the error bit of the second block 112.

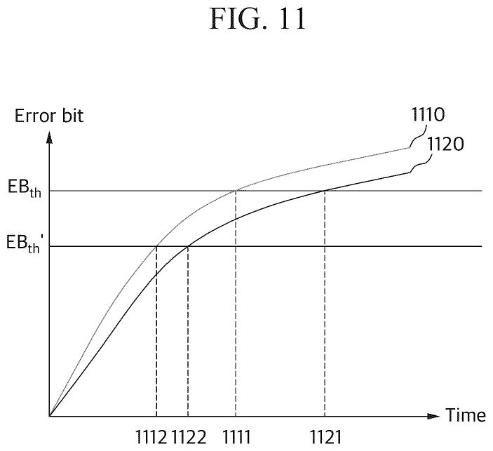

FIG. 11 is a graph which may assist in describing a method of moving a reclaim point according to example embodiments of the present disclosure.

Referring to FIG. 11, a reclaim point 1111 of the first block which is estimated based on a trend 1110 of an error bit of the first block and a threshold error bit EBₜₕ before a change, and a shifted reclaim point 1112 of the first block which is moved based on the trend 1110 of the first block and the changed threshold error bit EBₜₕ′ are illustrated.

According to an example embodiment, the at least one processor 220 may estimate a reclaim point 1122 of the second block based on a trend 1120 of an error bit of the second block and the changed threshold error bit EBₜₕ′. As an example, the at least one processor 220 may determine a trend 1120 of the error bit of the second block based on error bits of data read from the second block. In addition, the at least one processor 220 may estimate a point at which the determined trend 1120 of the error bit of the second block becomes the changed threshold error bit EBₜₕ′ as the reclaim point 1122 of the second block. That is, by determining the reclaim point 1122 of the second block based on the changed threshold error bit EBₜₕ′, the reclaim point 1122 of the second block which is programmed after the first block may be brought forward (i.e., earlier in time) than the reclaim point 1121 of the first block which is determined based on the threshold error bit EBₜₕ before the change.

Accordingly, the reclaim points of the plurality of blocks programmed after the threshold error bit is moved, as described with reference to FIG. 9, may be configured to perform a reclaim before the saturated unit time interval until the saturation of the reclaim of the memory device 100 is relieved.

According to an example embodiment, the at least one processor 220 may restore the changed threshold error bit EBₜₕ′ as a response to the relief of the saturation of the reclaim. As an example, the at least one processor 220 may restore the threshold error bit from the changed threshold error bit EBₜₕ′ to the threshold error bit EBₜₕ before the change as a response to the relief of the saturation of the reclaim.

According to an example embodiment, the at least one processor 220 may change the threshold error bit more than once. For example, when saturation of a reclaim is not relieved for a predetermined time even when the at least one processor 220 changed the threshold error bit from a first threshold error bit to a second threshold error bit, the threshold error bit may be changed one more time. For example, the at least one processor 220 may change the threshold error bit again into a third threshold error bit which is lower than the second threshold error bit.

Here, as a response to a relief of the saturation of the reclaim, the at least one processor 220 may restore the third threshold error bit into the second threshold error bit or the first threshold error bit which is the initial value. As an example, the at least one processor 220 may restore the threshold error bit based on at least one of the difference between the average of error bit of blocks corresponding to the saturated unit time interval and the average of error bits of blocks corresponding to the non-saturated unit time interval, and the number of the saturated unit time intervals. However, the example embodiment of the at least one processor 220 restoring the threshold error bit is not limited thereto.

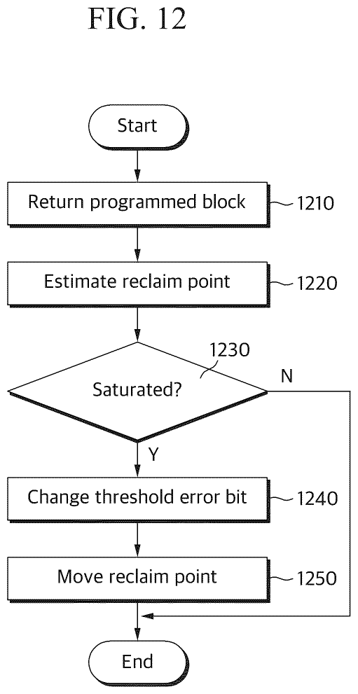

FIG. 12 is a flowchart illustrating an operation method of a memory controller according to example embodiments of the present disclosure.

Referring to FIG. 12, the at least one processor 220 (see FIG. 10) may return a programmed block in operation 1210. For example, the at least one processor 220 returning a programmed block may refer to the at least one processor 220 identifying a block address of the programmed block.

In operation 1220, the at least one processor 220 may estimate a reclaim point of the returned block.

According to an example embodiment, the at least one processor 220 may read data stored in the returned block more than once and detect error bits of the data read more than once to determine a trend of the error bit of the returned block.

According to an example embodiment, the at least one processor 220 may identify a reclaim point based on the trend of the error bit and a prescribed threshold error bit.

In operation 1230, the at least one processor 220 may determine whether the reclaim is saturated based on reclaim points of a plurality of blocks.

According to an example embodiment, the at least one processor 220 may identify the number of reclaim points included in a unit time interval and may identify a non-saturated unit time interval and saturated unit time interval by comparing the identified number and a threshold number.

According to an example embodiment, the at least one processor 220 may determine that a reclaim is saturated when saturated unit time intervals of a predetermined number or higher occurs. As illustrated in FIG. 12, when the reclaim is determined to be saturated, operation 1240 may be performed, and when the reclaim is not determined to be saturated, the algorithm according to an example embodiment may be terminated without performing operation 1250 of moving the reclaim point.

When the reclaimed is determined to be saturated, in operation 1240, the at least one processor 220 may change the threshold error bit. As an example, the at least one processor 220 may change the threshold error bit based on a difference between an average of error bits of blocks corresponding to the saturated unit time interval and an average of error bits of blocks corresponding to the non-saturated unit time interval. In addition, the at least one processor 220 may change the threshold error bit based on the number of saturated unit time intervals. Accordingly, the at least one processor 220 may re-identify the reclaim point based on the trend of the error bit of the returned block and changed threshold error bit.

In operation 1250, the at least one processor 220 may move at least one reclaim point among a plurality of reclaim points. As an example, the at least one processor 220 may move at least one reclaim point among the plurality of reclaim points based on the changed threshold error bit.

According to an example embodiment, the at least one processor 220 may restore the changed threshold error bit in response to a relief of the saturation of the reclaim. Alternatively, according to an example embodiment, when the reclaim is not determined to be saturated, the at least one processor 220 may determine whether the set threshold error bit is the changed error bit. In addition, the at least one processor 220 may restore the threshold error bit when the threshold error bit is determined to be the changed error bit, determining that the saturation of the reclaim has been relieved.

According to an example embodiment, when the threshold error bit is not determined to be the changed threshold error bit, the at least one processor 220 may returned the block and estimate a reclaim point of the returned block based on the threshold error bit.

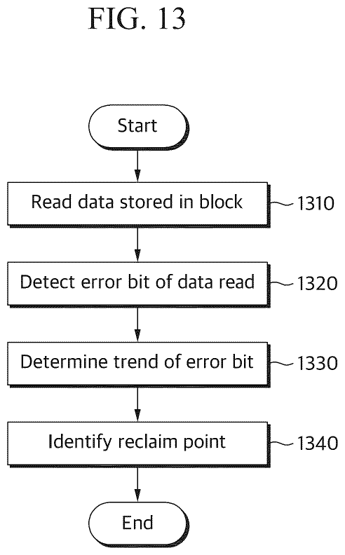

FIG. 13 is a flowchart illustrating an operation method of memory controller according to example embodiments of the present disclosure.

Referring to FIG. 13, the at least one processor 220 (see FIG. 10) may read data stored in a block in operation 1310. For example, the at least one processor 220 may read data stored in a programmed block more than once.

In operation 1320, the at least one processor 220 may detect an error bit of the data read. For example, the at least one processor 220 may detect an error bit of data which is read more than once.

In operation 1330, the at least one processor 220 may determine a trend of the error bit. Specifically, the at least one processor 220 may determine the trend of the error bit of the programmed block based on the error bits detected from the data stored in the programmed block.

In operation 1340, the at least one processor 220 may identify a reclaim point of the programmed block. For example, the at least one processor 220 may identify the reclaim point based on the trend of the error bit determined in operation 1330 and a threshold error bit. Accordingly, by estimating a reclaim point of a programmed block, reclaims points of a plurality of blocks may be scheduled appropriately according to various example embodiments.

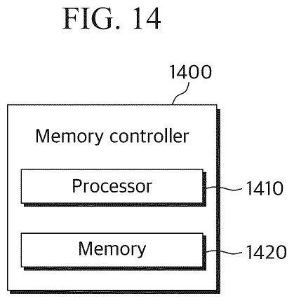

FIG. 14 is a block diagram of a memory controller according to example embodiments of the present disclosure.

Referring to FIG. 14, a memory controller 1400 may include a processor 1410 and a memory 1420. Only components related to the example embodiments are shown for the memory controller 1400 of FIG. 14. Therefore, it is to be understood by those skilled in the art that other general-purpose components may also be included in addition to the components illustrated in FIG. 14.

In addition, the memory controller 1400 and the processor 1410 included in the memory controller 1400 maybe the same as the memory controller 200 and the at least one processor 220, respectively, or perform the same functions as the memory 200 and the at least one processor 220.

In addition, although FIG. 14 illustrates a single processor 1410, the memory controller 1400 may include any number of processors, and each processor (among other possibilities) may be a single-core or multi-core processor, may implement a reduced instruction set computer (RISC) architecture or complex instruction set computer (CISC) architecture, or may be a combination thereof.

The memory 1420 may store a program for processing and controlling the processor 1410 as a hardware for storing different kinds of data processed within the memory controller 1400.

The memory 1420 may include a random-access memory (RAM), such as dynamic random-access memory (DRAM) and static random-access memory (SRAM), read-only memory (ROM), electrically erasable programmable read-only memory (EEPROM), CD-ROM, Blu-ray or other optical disc storage, hard disk drive (HDD), solid state drive (SSD), or flash memory.

The processor 1410 may control overall operations of the memory controller 1400. For example, the processor 1410 may have an overall control over an input unit (not shown), a display (not shown), a communication unit (not shown), and the memory 1420. The processor 1410 may control operations of the memory controller 1400 by executing programs stored in the memory 1420.

The processor 1410 may control at least one of operations of the memory device 100 or memory controller 200 described above with reference to FIGS. 1 through 13.

The processor 1410 may be implemented using at least one of application specific integrated circuits (ASICs), digital signal processors (DSPs), programmable logic devices (PLDs), field programmable gate arrays (FPGAs), controllers, micro-controllers, microprocessors, and electrical units for performing other functions.

According to an example embodiment, the memory controller 1400 may be a server. The server may be embodied as a single computer device or multiple computer devices that provide instructions, codes, files, contents, and services by communicating through a network.

Meanwhile, the memory controller 1400 may also include a communication unit (not shown). The communication unit (not shown) may include at least one component that allows for wire/wireless communication with an external server or external device. For example, the communication unit (not shown) may include at least one of a close-range communication unit (not shown), mobile communication unit (not shown), and broadcast receiver.

The electronic device according to the above-described example embodiments may include a processor, a memory for storing program data and executing the stored program data, a permanent storage such as a disk drive, a communications port for communicating with external devices, a user interface device such as a touch panel, a key and a button, and the like. Methods applied by software modules or algorithms may be stored in a computer-readable recording medium as computer-readable codes or program commands which may be executed by a processor. Here, the computer-readable recording medium may be a magnetic storage (such as a read-only memory (ROM), a random-access memory (RAM), a floppy disk, and a hard disk), an optical storage (such as a CD-ROM, and a digital versatile disc (DVD)), and the like. Digital Versatile Disc)). The computer-readable recording medium may be dispersed to computer systems connected by a network so that computer-readable codes may be stored and executed in a dispersion manner. The medium may be read by a computer, may be stored in a memory, and may be executed by the processor.

The example embodiments may be represented by functional blocks and various processing steps. These functional blocks may be implemented by various numbers of hardware and/or software configurations that execute specific functions. For example, the example embodiments may adopt direct circuit configurations such as a memory, a processor, a logic circuit, and a look-up table that may execute various functions by control of one or more microprocessors or other control devices. Similarly to that elements may be executed by software programming or software elements, the example embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the example embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

The example embodiments described above are merely examples and other embodiments may be implemented within the scope of the following claims.

What is claimed is:

1. An operation method of a memory controller, the operation method comprising:
estimating, based on an error bit of a first memory block which is programmed among a plurality of memory blocks included in a memory device, a reclaim point of the first memory block;
determining whether a reclaim is saturated based on a plurality of reclaim points of the plurality of memory blocks; and
when the reclaim is determined to be saturated, moving at least one reclaim point among the plurality of reclaim points.

2. The operation method of claim 1, wherein estimating the reclaim point comprises:
determining, based on the error bit, a trend of the error bit; and
identifying the reclaim point based on the trend of the error bit and a threshold error bit.

3. The operation method of claim 2, wherein determining the trend of the error bit comprises:
reading data stored in the first memory block more than once; and
detecting error bits of the data read more than once.

4. The operation method of claim 2, wherein determining whether the reclaim is saturated comprises:
identifying a number of reclaim points, among the plurality of reclaim points, included in a unit time interval; and
comparing the number of reclaim points with a threshold number.

5. The operation method of claim 4, wherein determining whether the reclaim is saturated further comprises:
identifying a non-saturated unit time interval in which the number of reclaim points is less than the threshold number; and
identifying a saturated unit time interval in which the number of reclaim points is more than or equal to the threshold number.

6. The operation method of claim 5, wherein determining whether the reclaim is saturated comprises determining that a saturation has occurred when multiple of the saturated unit time interval appear consecutively a predetermined number of times or more.

7. The operation method of claim 5, wherein moving the at least one reclaim point comprises changing the threshold error bit.

8. The operation method of claim 7, wherein changing the threshold error bit comprises changing the threshold error bit based on a difference between an average of error bits of memory blocks corresponding to the saturated unit time interval and an average of error bits of the memory blocks corresponding to the non-saturated unit time interval.

9. The operation method of claim 7, wherein changing the threshold error bit comprises changing the threshold error bit based on a number of the saturated unit time interval.

10. The operation method of claim 7, further comprising estimating, based on a trend of an error bit of a second memory block which is programmed among the plurality of memory blocks and the changed threshold error bit, a reclaim point of the second memory block.

11. The operation method of claim 4, further comprising restoring the threshold error bit in response to determining that the reclaim is non-saturated.

12. A memory controller, comprising:
at least one processor configured to control a memory device which includes a plurality of memory blocks,
wherein the at least one processor is configured:
to estimate, based on an error bit of a first memory block which is programmed among the plurality of memory blocks, a reclaim point of the first memory block,
to determine whether a reclaim is saturated based on a plurality of reclaim points of the plurality of memory blocks, and
to move at least one reclaim point among the plurality of reclaim points when the reclaim is determined to be saturated.

13. The memory controller of claim 12, wherein the at least one processor is configured to determine, based on the error bit, a trend of the error bit, and
to identify the reclaim point based on the trend of the error bit and a threshold error bit.

14. The memory controller of claim 13, wherein the at least one processor is configured to read data stored in the first memory block more than once, and
to detect error bits of the data read more than once.

15. The memory controller of claim 13, wherein the at least one processor is configured to identify a number of reclaim points included in a unit time interval, and to compare the number of reclaim points and a threshold number.

16. The memory controller of claim 15, wherein the at least one processor is configured to identify a non-saturated unit time interval in which the number of reclaim points is less than the threshold number, and
to identify a saturated unit time interval in which the number of reclaim points is more than or equal to the threshold number.

17. The memory controller of claim 16, wherein the at least one processor is configured to change the threshold error bit based on a difference between an average of error bits of memory blocks corresponding to the saturated unit time interval and an average of error bits of memory blocks corresponding to the non-saturated unit time interval.

18. The memory controller of claim 17, wherein the at least one processor is configured to estimate, based on a trend of an error bit of a second memory block which is programmed among the plurality of memory blocks and the changed threshold error bit, a reclaim point of the second memory block.

19. The memory controller of claim 15, wherein the at least one processor is configured to restore the threshold error bit when the reclaim is non-saturated.

20. A storage device, comprising:
a memory device including a plurality of memory blocks; and
a memory controller configured to write data to the memory device in response to a write request,
wherein the memory controller is configured:
to transmit a write command to the memory device to program a first memory block among the plurality of memory blocks,
to estimate a reclaim point of the first memory block based on an error bit of the first memory block,
to determine whether a reclaim is saturated based on a plurality of reclaim points of the plurality of memory blocks, and
to move at least one reclaim point among the plurality of reclaim points when the reclaim is determined to be saturated.
